(19) United States
(12) Patent Application Publication
(10) Pub. No.: US 2024/0362135 A1
(43) Pub. Date: Oct. 31, 2024

(54) METHOD FOR VERIFYING A MACHINE LEARNING ALGORITHM

(71) Applicant: Robert Bosch GmbH, Stuttgart (DE)

(72) Inventors: Laura Beggel, Stuttgart (DE); Thi Phuong Nhung Ngo, Karlsruhe (DE)

(21) Appl. No.: 18/643,317

(22) Filed: Apr. 23, 2024

(30) Foreign Application Priority Data
Apr. 28, 2023 (DE) 10 2023 203 998.2

(51) Int. Cl. G06F 11/28

(52) U.S. Cl. CPC G06F 11/28

(57) ABSTRACT

A method for verifying a machine learning algorithm. The method includes: providing test data sets for testing a machine learning algorithm trained based on a training data set, wherein none of the test data sets has a common element with the training data set; respectively ascertaining, for each of the plurality of test data sets, a value of the similarity between the corresponding test data set and the training data set; respectively generating, for each of the plurality of test data sets, a test result by testing the machine learning algorithm based on the elements of the corresponding test data set; verifying the machine learning algorithm based on the values of the similarity of all of the plurality of test data sets and the test results of all of the plurality of test data sets in order to generate verification results; and providing the verification results.

### FIELD

The present invention relates to a method for verifying a machine learning algorithm with which a degree of generalization of a machine learning algorithm trained by a deep learning method can be ascertained in a simple manner and with comparatively few resources.

### BACKGROUND INFORMATION

Machine learning algorithms are based on using statistical methods to train a data processing system in such a way that it can perform a particular task without it being originally programmed explicitly for this purpose. The goal of machine learning is to construct algorithms that can learn and make predictions from data. These algorithms create mathematical models with which data can be classified, for example.

A machine learning algorithm trained by a deep learning method is furthermore understood to be a machine learning algorithm trained on the basis of a labeled training data set or a training data set provided with ground truth information.

Alternatively, the model may, for example, be trained in an unsupervised manner (i.e., without labels).

However, the disadvantage of such deep learning methods is that overfitting can occur if the corresponding machine learning algorithm provides accurate predictions for training data, but not for new data. Consequently, there is a need for methods for checking a generalization or scaling of a machine learning algorithm in order to ensure that a generalization of a trained machine learning algorithm is as optimal as possible before a corresponding training process is terminated.

However, common methods for checking a generalization of a machine learning algorithm are based on complex algorithms, wherein large amounts of data are required and the processing of the large amounts of data is associated with a high consumption of resources, for example a high consumption of memory capacities and/or processor capacities.

German Patent Application No. DE 10 2017 212 328 A1 describes a method for training an artificial intelligence module which translates input variables into output variables by means of a parameterized internal processing chain, wherein the parameters of the processing chain are ascertained in such a way that learning values of the input variables are translated into the matching learning values of the output variables, wherein the learning values of the input variables are superimposed with a specified test pattern and a response is ascertained which causes the test pattern in the values of the output variables provided by the internal processing chain.

An object of the present invention is to provide an improved method for checking a generalization of a machine learning algorithm.

The object may be achieved by a method for verifying a machine learning algorithm according to features of the present invention.

The object may also be achieved by a system for verifying a machine learning algorithm according to features of the present invention.

### SUMMARY

According to an example embodiment of the present invention, this object may be achieved by a method for verifying a machine learning algorithm, wherein the method comprises providing a plurality of test data sets for testing a machine learning algorithm trained on the basis of a training data set, wherein none of the test data sets has a common element with the training data set; respectively ascertaining, for each of the plurality of test data sets, a value of the similarity between the corresponding test data set and the training data set; respectively generating, for each of the plurality of test data sets, a test result by testing the machine learning algorithm on the basis of the elements of the corresponding test data set; verifying the machine learning algorithm on the basis of the values of the similarity of all of the plurality of test data sets and the test results of all of the plurality of test data sets in order to generate verification results; and providing the verification results.

Training data are instances or data that are used to train the learning algorithm, i.e., to learn a model or a machine learning algorithm. The test data, on the other hand, are not used to learn the model but to measure the quality of the model.

None of the test data sets having a common element with the training data set means that they are each disjunct sets or held-out test data sets.

A value of the similarity is furthermore understood to be a measure or a value that describes or represents the similarity between a test data set and the training data set.

On the basis of the values of the similarity and the corresponding test results, the degree of a generalization of the trained machine learning algorithm can subsequently be deduced in a simple manner and with significantly lower consumption of resources. In particular, the method can also be performed in control units that have comparatively few resources, for example control units of a motor vehicle.

Overall, an improved method for checking a generalization of a machine learning algorithm is thus provided.

According to an example embodiment of the present invention, the step of respectively ascertaining, for each of the plurality of test data sets, a value of the similarity between the corresponding test data set and the training data set can respectively comprise ascertaining an average similarity between at least some of the elements of the corresponding test data set and at least some of the elements of the training data set.

An average similarity being ascertained means that a similarity value is respectively ascertained for each combination of an element of the corresponding test data set and of the training data set and an average of the ascertained similarity values is subsequently ascertained.

The value of the similarity can thus in each case be ascertained on the basis of simple algorithms without the need for complex and resource-intensive algorithms.

In particular, according to an example embodiment of the present invention, the step of respectively ascertaining, for each of the plurality of test data sets, a value of the similarity between the corresponding test data set and the training data set can respectively comprise ascertaining label-wise an average similarity between at least some of the elements of the corresponding test data set and at least some of the elements of the training data set.

Labels are the categories of data into which the data sets are to be classified. Ascertaining an average similarity label-wise means that a separate average similarity is respectively ascertained for each label.

This makes it possible to still further specify or refine the verification results or the information about the generalization.

In addition, the training data set and/or the plurality of test data sets may comprise sensor data.

A sensor, which is also referred to as a detector, (measurement or measuring) transmitter or (measuring) probe, is furthermore a technical component which can detect certain physical or chemical properties and/or the material nature of its surroundings qualitatively or quantitatively as a measured variable.

Information outside the data processing system in which the method is performed can thus also be included and used to ascertain the verification results.

With a further example embodiment of the present invention, a method for training a machine learning algorithm is also provided, wherein the method comprises providing training data for training the machine learning algorithm; providing verification results, wherein the verification results were generated by an above-described method for verifying a machine learning algorithm; training the machine learning algorithm on the basis of the training data and the verification results; and providing the trained machine learning algorithm.

A method for training a machine learning algorithm which is based on an improved method for checking a generalization of a machine learning algorithm is thus specified. On the basis of the values of the similarity and the corresponding test results, the degree of a generalization of the trained machine learning algorithm can in this case be deduced in a simple manner and with significantly lower consumption of resources. In particular, generating verification results can also be performed in control units that have comparatively few resources, for example control units of a motor vehicle. On the basis of the verification results, it can also be ensured, for example, that a generalization of a trained machine learning algorithm is as optimal as possible before the training process is terminated.

With a further example embodiment of the present invention, a method for classifying image data is furthermore also provided, wherein image data are classified using a machine learning algorithm which has been trained to classify image data, and wherein the machine learning algorithm has been trained using an above-described method for training a machine learning algorithm.

In particular, the method of the present invention can be used to classify image data, in particular digital image data, on the basis of low-level features, for example edges or pixel attributes. In this case, an image processing algorithm can furthermore be used to analyze a classification result which is focused on corresponding low-level features.

A method for classifying image data which is based on a machine learning algorithm trained on the basis of an improved method for checking a generalization of a machine learning algorithm is thus provided according to the present invention. On the basis of the values of the similarity and the corresponding test results, the degree of a generalization of the trained machine learning algorithm can in this case be deduced in a simple manner and with significantly lower consumption of resources. In particular, generating verification results can also be performed in control units that have comparatively few resources, for example control units of a motor vehicle. On the basis of the verification results, it can also be ensured, for example, that a generalization of a trained machine learning algorithm is as optimal as possible before the training process is terminated.

With a further example embodiment of the present invention, a system for verifying a machine learning algorithm is furthermore also provided, wherein the system comprises a first providing unit designed to provide a plurality of test data sets for testing a machine learning algorithm trained on the basis of a training data set, wherein none of the test data sets has a common element with the training data set; an ascertaining unit designed to respectively ascertain, for each of the plurality of test data sets, a value of the similarity between the corresponding test data set and the training data set; a generating unit designed to respectively generate, for each of the plurality of test data sets, a test result by testing the machine learning algorithm on the basis of the elements of the corresponding test data set; a verifying unit designed to verify the machine learning algorithm on the basis of the values of the similarity of all of the plurality of test data sets and the test results of all of the plurality of test data sets in order to generate verification results; and a second providing unit designed to provide the verification results.

An improved system for checking a generalization of a machine learning algorithm is thus provided according to the present invention. On the basis of the values of the similarity and the corresponding test results, the degree of a generalization of the trained machine learning algorithm can in this case be deduced in a simple manner and with significantly lower consumption of resources. In particular, verifying can also be performed in control units that have comparatively few resources, for example control units of a motor vehicle.

In this case, according to an example embodiment of the present invention, the ascertaining unit can be designed to respectively ascertain an average similarity between at least some of the elements of the corresponding test data set and at least some of the elements of the training data set. The value of the similarity can thus in each case be ascertained on the basis of simple algorithms without the need for complex and resource-intensive algorithms.

In particular, the ascertaining unit can be designed to respectively ascertain label-wise an average similarity between at least some of the elements of the corresponding test data set and at least some of the elements of the training data set. This makes it possible to still further specify or refine the verification results or the information about the generalization.

In addition, the training data set and/or the plurality of test data sets can again comprise sensor data. Information outside the data processing system in which verifying is performed can thus also be included and used to ascertain the verification results.

With a further example embodiment of the present invention, a system for training a machine learning algorithm is additionally also provided, wherein the system comprises a first providing unit designed to provide training data for training the machine learning algorithm; a second providing unit designed to provide verification results, wherein the verification results have been generated by an above-described system for verifying a machine learning algorithm; a training unit designed to train the machine learning algorithm on the basis of the training data and the verification results; and a third providing unit designed to provide the trained machine learning algorithm.

A system for training a machine learning algorithm which is based on an improved system for checking a generalization of a machine learning algorithm is thus provided according to the present invention. On the basis of the values of the similarity and the corresponding test results, the degree of a generalization of the trained machine learning algorithm can in this case be deduced in a simple manner and with significantly lower consumption of resources. In particular, generating verification results can also be performed in control units that have comparatively few resources, for example control units of a motor vehicle. On the basis of the verification results, it can also be ensured, for example, that a generalization of a trained machine learning algorithm is as optimal as possible before the training process is terminated.

With a further example embodiment of the present invention, a system for classifying image data is additionally also provided, wherein image data are classified using a machine learning algorithm which has been trained to classify image data, and wherein the machine learning algorithm has been trained using an above-described system for training a machine learning algorithm.

In particular, the system can be used to classify image data, in particular digital image data, on the basis of low-level features, for example edges or pixel attributes. In this case, an image processing algorithm can furthermore be used to analyze a classification result which is focused on corresponding low-level features.

A system for classifying image data which is based on a machine learning algorithm trained on the basis of an improved system for checking a generalization of a machine learning algorithm is thus provided according to the present invention. On the basis of the values of the similarity and the corresponding test results, the degree of a generalization of the trained machine learning algorithm can in this case be deduced in a simple manner and with significantly lower consumption of resources. In particular, generating verification results can also be performed in control units that have comparatively few resources, for example control units of a motor vehicle. On the basis of the verification results, it can also be ensured, for example, that a generalization of a trained machine learning algorithm is as optimal as possible before the training process is terminated.

With a further example embodiment of the present invention, a computer program is additionally also provided, comprising program code for performing an above-described method for verifying a machine learning algorithm when the computer program is executed in a computer.

With a further example embodiment of the present invention, a computer-readable data carrier is additionally also provided, comprising program code of a computer program for performing an above-described method for verifying a machine learning algorithm when the computer program is executed in a computer.

The computer program and the computer-readable data carrier each have the advantage of being designed to perform an improved method for checking a generalization of a machine learning algorithm. On the basis of the values of the similarity and the corresponding test results, the degree of a generalization of the trained machine learning algorithm can in this case be deduced in a simple manner and with significantly lower consumption of resources. In particular, verifying can also be performed in control units that have comparatively few resources, for example control units of a motor vehicle.

In summary, it should be noted that the present invention provides a method for verifying a machine learning algorithm with which a degree of generalization of a machine learning algorithm trained by a deep learning method can be ascertained in a simple manner and with comparatively few resources.

The described embodiments and developments of the present invention can be combined with one another as desired.

Further possible embodiments, developments and implementations of the present invention also include combinations not explicitly mentioned of features of the present invention described above or in the following relating to the exemplary embodiments of the present invention.

### BRIEF DESCRIPTION OF THE DRAWINGS

The figures are intended to impart further understanding of the example embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a flowchart of a method for verifying a machine learning algorithm according to example embodiments of the present invention.

FIG. 2 is a schematic block diagram of a system for verifying a machine learning algorithm according to example embodiments of the present invention.

### DETAILED DESCRIPTION OF EXAMPLE EMBODIMENTS

In the figures, identical reference signs denote identical or functionally identical elements, parts or components, unless stated otherwise.

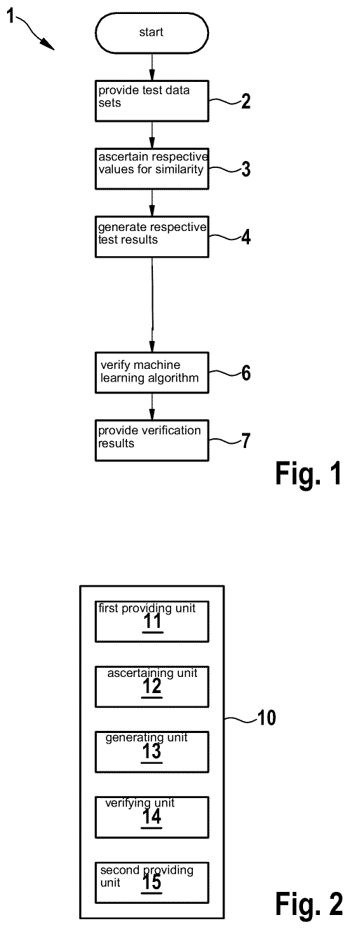

FIG. 1 is a flowchart of a method for verifying a machine learning algorithm 1 according to example embodiments of the present invention.

The disadvantage of deep learning methods of machine learning algorithms is that overfitting can occur if the corresponding machine learning algorithm provides accurate predictions for training data, but not for new data. Consequently, there is a need for methods for checking a generalization or scaling of a machine learning algorithm in order to ensure that a generalization of a trained machine learning algorithm is as optimal as possible before a corresponding training process is terminated.

However, common methods for checking a generalization of a machine learning algorithm are based on complex algorithms, wherein large amounts of data are required and the processing of the large amounts of data is associated with a high consumption of resources, for example a high consumption of memory capacities and/or processor capacities.

FIG. 1. shows a method 1, which comprises a step 2 of providing a plurality of test data sets for testing a machine learning algorithm trained on the basis of a training data set, wherein none of the test data sets has a common element with the training data set; a step 3 of respectively ascertaining, for each of the plurality of test data sets, a value of the similarity between the corresponding test data set and the training data set; a step 4 of respectively generating, for each of the plurality of test data sets, a test result by testing the machine learning algorithm on the basis of the elements of the corresponding test data set; a step 6 of verifying the machine learning algorithm on the basis of the values of the similarity of all of the plurality of test data sets and the test results of all of the plurality of test data sets in order to generate verification results; and a step 7 of providing the verification results.

On the basis of the values of the similarity and the corresponding test results, the degree of a generalization of the trained machine learning algorithm can in this case be subsequently deduced in a simple manner and with significantly lower consumption of resources. In particular, the method 1 can also be performed in control units that have comparatively few resources, for example control units of a motor vehicle.

Overall, an improved method for checking a generalization of a machine learning algorithm 1 is thus provided.

FIG. 1 thus shows a method 1 for testing the generalization of a machine learning algorithm, in particular a machine learning algorithm trained by a deep learning method.

The machine learning algorithm can be a deep neural network, for example.

The training data contained in the training data set and the test data contained in the test data sets may each, for example, furthermore comprise image data, in particular image data representing a product produced by a manufacturing process, for example a semiconductor wafer.

Step 6 of verifying, or the evaluation of the values of the similarity and the test results, can furthermore comprise applying a Pearson correlation.

The Pearson correlation is a simple way of determining the linear relationship between two variables. The Pearson correlation coefficient serves as a measure of the strength of the correlation between the interval-scaled features and usually assumes values between −1 and 1. In particular, the Pearson correlation coefficient is a quantitative measure of assessing the strength of the relationship between two continuous features. Thus, the further away the test data are from the training data set, the worse the corresponding test results should usually be.

The value of the similarity can in each case be ascertained on the basis of vector distances.

According to the embodiments of FIG. 1, step 3 of respectively ascertaining, for each of the plurality of test data sets, a value of the similarity between the corresponding test data set and the training data set respectively comprises ascertaining an average similarity between at least some of the elements of the corresponding test data set and at least some of the elements of the training data set.

According to the embodiments of FIG. 1, the step of respectively ascertaining, for each of the plurality of test data sets, a value of the similarity between the corresponding test data set and the training data set respectively comprises ascertaining label-wise an average similarity between at least some of the elements of the corresponding test data set and at least some of the elements of the training data set.

The training data set and the plurality of test data sets furthermore each comprise sensor data, for example data detected by at least one optical sensor during or after completion of a manufacturing process, which data represent a product produced by the manufacturing process.

The corresponding verification results can, for example, be subsequently used to optimize the training of the machine learning algorithm. A correspondingly optimized machine learning algorithm can, for example, be subsequently used for image classification, for example as part of an automatic optical inspection during and/or after the production of products by a manufacturing process, wherein products identified as faulty can, for example, be subsequently discarded automatically.

FIG. 2 is a schematic block diagram of a system for verifying a machine learning algorithm 10 according to embodiments of the present invention.

As FIG. 2 shows, the system 10 comprises a first providing unit 11 designed to provide a plurality of test data sets for testing a machine learning algorithm trained on the basis of a training data set, wherein none of the test data sets has a common element with the training data set; an ascertaining unit 12 designed to respectively ascertain, for each of the plurality of test data sets, a value of the similarity between the corresponding test data set and the training data set; a generating unit 13 designed to respectively generate, for each of the plurality of test data sets, a test result by testing the machine learning algorithm on the basis of the elements of the corresponding test data set; a verifying unit 14 designed to verify the machine learning algorithm on the basis of the values of the similarity of all of the plurality of test data sets and the test results of all of the plurality of test data sets in order to generate verification results; and a second providing unit 15 designed to provide the verification results.

The first providing unit can in particular be a receiver that is designed to receive corresponding data, for example sensor data. The second providing unit can in particular be a transmitter that is designed to send or transmit corresponding data. The first providing unit and the second providing unit can also be integrated into a common transceiver.

The ascertaining unit, the generating unit, and the verifying unit can each, for example, furthermore be realized on the basis of a code that is stored in a memory and can be executed by a processor.

According to the embodiments of FIG. 2, the ascertaining unit 12 is designed to respectively ascertain an average similarity between at least some of the elements of the corresponding test data set and at least some of the elements of the training data set.

In particular, the ascertaining unit 12 is designed to respectively ascertain label-wise an average similarity between at least some of the elements of the corresponding test data set and at least some of the elements of the training data set.

The training data set the plurality of test data sets furthermore each comprise sensor data, for example data detected by at least one optical sensor during or after completion of a manufacturing process, which data represent a product produced by the manufacturing process.

The system 10 shown is also designed to perform an above-described method for verifying a machine learning algorithm.

1-14. (canceled)

15. A method, comprising:
verifying a machine learning algorithm, the verifying including the following steps:
providing a plurality of test data sets for testing a machine learning algorithm trained based on a training data set, wherein none of the test data sets has a common element with the training data set;
respectively ascertaining, for each test data set of the plurality of test data sets, a value of the similarity between the test data set and the training data set;
respectively generating, for each test data set of the plurality of test data sets, a test result by testing the machine learning algorithm based on elements of the test data set;
verifying the machine learning algorithm based on the values of the similarity of all of the plurality of test data sets and the test results of all of the plurality of test data sets in order to generate verification results; and
providing the verification results.

16. The method according to claim 15, wherein the step of respectively ascertaining, for each test data set of the plurality of test data sets, the value of the similarity between the test data set and the training data set respectively includes ascertaining an average similarity between at least some of the elements of the test data set and at least some of the elements of the training data set.

17. The method according to claim 16, wherein the step of respectively ascertaining, for each test data set of the plurality of test data sets, the value of the similarity between the test data set and the training data set respectively includes ascertaining label-wise an average similarity between at least some of the elements of the test data set and at least some of the elements of the training data set.

18. The method according to claim 15, wherein the training data set and/or the plurality of test data sets include sensor data.

19. The method according to claim 15, further comprising:
training the machine learning algorithm, including:
providing training data for the training data set for training the machine learning algorithm;
training the machine learning algorithm based on the training data and the verification results; and
providing the trained machine learning algorithm.

20. The method according to claim 19, further comprising:
classifying image data, wherein the image data are classified using the trained machine learning algorithm, wherein the trained machine learning algorithm has been trained to classify image data.

21. A system for verifying a machine learning algorithm, comprising:
a first providing unit configured to provide a plurality of test data sets for testing a machine learning algorithm trained based on a training data set, wherein none of the test data sets has a common element with the training data set;
an ascertaining unit configured to respectively ascertain, for each test data set of the plurality of test data sets, a value of the similarity between the test data set and the training data set;
a generating unit configured to respectively generate, for each test data set of the plurality of test data sets, a test result by testing the machine learning algorithm based on the test data set;
a verifying unit configured to verify the machine learning algorithm based on the basis of the values of the similarity of all of the plurality of test data sets and the test results of all of the plurality of test data sets in order to generate verification results; and
a second providing unit configured to provide the verification results.

22. The system according to claim 21, wherein the ascertaining unit is configured to respectively ascertain an average similarity between at least some elements of the test data set and at least some of elements of the training data set.

23. The system according to claim 22, wherein the ascertaining unit is configured to respectively ascertain label-wise an average similarity between at least some elements of the test data set and at least some of elements of the training data set.

24. The system according to claim 21, wherein the training data set and/or the plurality of test data sets include sensor data.

25. A system for training a machine learning algorithm, the system comprising:
a first providing unit configured to provide training data for training the machine learning algorithm;
a second providing unit configured to provide verification results, wherein the verification results have been generated by a system for verifying a machine learning algorithm including:
a third providing unit configured to provide a plurality of test data sets for testing a machine learning algorithm trained based on a training data set, wherein none of the test data sets has a common element with the training data set,
an ascertaining unit configured to respectively ascertain, for each test data set of the plurality of test data sets, a value of the similarity between the test data set and the training data set,
a generating unit configured to respectively generate, for each test data set of the plurality of test data sets, a test result by testing the machine learning algorithm based on the test data set,
a verifying unit configured to verify the machine learning algorithm based on the basis of the values of the similarity of all of the plurality of test data sets and the test results of all of the plurality of test data sets in order to generate verification results, and
a fourth providing unit configured to provide the verification results; and
a training unit configured to train the machine learning algorithm based on the the training data and the verification results; and
a fifth providing unit configured to provide the trained machine learning algorithm.

26. A system for classifying image data, wherein image data are classified using a machine learning algorithm which has been trained to classify image data, and wherein the machine learning algorithm has been trained using a system for training a machine learning algorithm including:
a first providing unit configured to provide training data for training the machine learning algorithm;
a second providing unit configured to provide verification results, wherein the verification results have been generated by a system for verifying a machine learning algorithm including:
a third providing unit configured to provide a plurality of test data sets for testing a machine learning algorithm trained based on a training data set, wherein none of the test data sets has a common element with the training data set,
an ascertaining unit configured to respectively ascertain, for each test data set of the plurality of test data sets, a value of the similarity between the test data set and the training data set,
a generating unit configured to respectively generate, for each test data set of the plurality of test data sets, a test result by testing the machine learning algorithm based on the test data set,
a verifying unit configured to verify the machine learning algorithm based on the basis of the values of the similarity of all of the plurality of test data sets and the test results of all of the plurality of test data sets in order to generate verification results, and
a fourth providing unit configured to provide the verification results; and
a training unit configured to train the machine learning algorithm based on the the training data and the verification results; and
a fifth providing unit configured to provide the trained machine learning algorithm.

27. A non-transitory computer-readable data carrier on which is stored program code of a computer program for verifying a machine learning algorithm, the program code, when executed by a computer, causing the computer to perform the following steps:
providing a plurality of test data sets for testing a machine learning algorithm trained based on a training data set, wherein none of the test data sets has a common element with the training data set;
respectively ascertaining, for each test data set of the plurality of test data sets, a value of the similarity between the test data set and the training data set;
respectively generating, for each test data set of the plurality of test data sets, a test result by testing the machine learning algorithm based on elements of the test data set;
verifying the machine learning algorithm based on the values of the similarity of all of the plurality of test data sets and the test results of all of the plurality of test data sets in order to generate verification results; and
providing the verification results.
